(19) United States
(12) Patent Application Publication
(10) Pub. No.: US 2024/0162463 A1
(43) Pub. Date: May 16, 2024

(54) DEVICE FOR DETERMINING WATER CONTENT STATE OF FUEL CELL STACK AND FUEL CELL VEHICLE

(71) Applicant: SUBARU CORPORATION, Tokyo (JP)

(72) Inventor: Yushi FUKUTOMI, Tokyo (JP)

(73) Assignee: SUBARU CORPORATION, Tokyo (JP)

(21) Appl. No.: 18/385,949

(22) Filed: Nov. 1, 2023

(30) Foreign Application Priority Data
Nov. 15, 2022 (JP) 2022-182593

(51) Int. Cl. H01M 8/04746; H01M 8/04537

(52) U.S. Cl. CPC H01M 8/04761; H01M 8/04559; H01M 8/04589; H01M 2250/20

(57) ABSTRACT

A device includes a control unit. The control unit is configured to determine a water content state of a fuel cell stack including one or more cells based on impedance measurement obtained by applying a load waveform for the impedance measurement to the fuel cell stack. The control unit is configured to: determine whether the one or more cells of the fuel cell stack are in a dry state according to whether a value of membrane resistance of the one or more cells based on the impedance measurement exceeds a first threshold; and determine that the one or more cells are in a flooding state when the value of the membrane resistance is smaller than or equal to the first threshold and when a degree of variations on a low-frequency side in the impedance measurement exceeds a second threshold.

### CROSS-REFERENCE TO RELATED APPLICATION

The present application claims priority from Japanese Patent Application No. 2022-182593 filed on Nov. 15, 2022, the entire contents of which are hereby incorporated by reference.

### BACKGROUND

The disclosure relates to a device for determining the water content state of, for example, a fuel cell stack, and to a fuel cell vehicle including this device.

In present-day society, the means of transportation are almost essential and various types of vehicles, such as automobiles, are running on the road in everyday life. As a new drive source for supplying drive power to vehicles, fuel cells, which produce relatively small impact on the environments, are attracting people's attention.

In a fuel cell, a fuel gas (hydrogen) is supplied to one electrode (fuel electrode), while an oxidizer gas (oxygen) is supplied to the other electrode (air electrode). The fuel gas and the oxidizer gas chemically react with each other, thereby producing electric energy. To continuously obtain electric energy (generated electric power) from a fuel cell loaded in a vehicle, the internal state of the fuel cell is to suitably be determined.

Regarding the determination of the internal state of a fuel cell, Japanese Unexamined Patent Application Publication (JP-A) No. 2018-181534, for example, proposes a technology for determining the internal state of a fuel cell based on a water content in an electrolyte membrane of a fuel cell. JP-A No. 2018-181534 describes that the occurrence of measurement errors for the water content is dependent on the phase difference of a low frequency in an alternating current (AC) signal used for impedance measurement and proposes that, when such a measurement error is large, a calculated value is not utilized as that for the water content of a fuel cell.

### SUMMARY

An aspect of the disclosure provides a device includes a control unit. The control unit is configured to determine a water content state of a fuel cell stack including one or more cells based on impedance measurement obtained by applying a load waveform for the impedance measurement to the fuel cell stack. The control unit is configured to: determine whether the one or more cells of the fuel cell stack are in a dry state according to whether a value of membrane resistance of the one or more cells based on the impedance measurement exceeds a first threshold; and determine that the one or more cells are in a flooding state when the value of the membrane resistance is smaller than or equal to the first threshold and when a degree of variations on a low-frequency side in the impedance measurement exceeds a second threshold. A value of the second threshold is different from a value of the first threshold.

An aspect of the disclosure provides a device includes circuitry. The circuitry is configured to determine a water content state of a fuel cell stack including one or more cells based on impedance measurement obtained by applying a load waveform for the impedance measurement to the fuel cell stack. The circuitry is configured to: determine whether the one or more cells of the fuel cell stack are in a dry state according to whether a value of membrane resistance of the one or more cells based on the impedance measurement exceeds a first threshold; and determine that the one or more cells are in a flooding state when the value of the membrane resistance is smaller than or equal to the first threshold and when a degree of variations on a low-frequency side in the impedance measurement exceeds a second threshold. A value of the second threshold is different from a value of the first threshold.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic view illustrating an example of the configuration of a fuel cell vehicle equipped with a device for determining the water content state of a fuel cell according to an embodiment;

FIG. 2 is a schematic view illustrating elements and functions of the fuel cell vehicle according to the embodiment;

FIG. 3 is a schematic block diagram illustrating examples of elements of a control unit according to the embodiment and examples of elements of peripheral devices;

FIG. 4 is a flowchart illustrating a method for determining the water content state of a fuel cell according to the embodiment;

FIG. 5 is a schematic diagram for explaining how to determine the membrane resistance in the method for determining the water content state of a fuel cell;

FIGS. 6A through 6C are schematic diagrams for explaining an example of low-frequency variation determining processing in the method for determining the water content state of a fuel cell;

FIGS. 7A and 7B are schematic diagrams for explaining another example of low-frequency variation determining processing in the method for determining the water content state of a fuel cell; and

FIGS. 8A through 8C are enlarged schematic diagrams illustrating the portions surrounded by the rectangular frames in FIGS. 7A and 7B.

### DETAILED DESCRIPTION

Current technologies including that disclosed in JP-A No. 2018-181534 do not seem to satisfy market needs and still leave room for improvement in terms of the following issue.

As a method for estimating the internal state of a fuel cell, an AC impedance method is typically used, as described in JP-A No. 2018-181534. As pointed out in JP-A No. 2018-181534, however, the measurement accuracy in impedance measurement on the low-frequency side of an AC signal is low and errors may occur.

To address this issue, JP-A No. 2018-181534 proposes that, when a measurement error is large, a calculated value is not utilized as that for the water content of a fuel cell. Although this approach is effective, failing to measure the water content of a fuel cell upon the occurrence of a measurement error is not convenient.

It is desirable to provide a water content state determining device that can determine the water content state of a fuel cell by effectively utilizing the low-frequency side of an AC signal used for measurement and also to provide a fuel cell vehicle including this device.

In the following, an embodiment of the disclosure is described in detail with reference to the accompanying drawings. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description. For the configurations of elements other than those discussed in detail below, technologies and configurations of elements of known fuel cell systems and fuel cell vehicles, for example, may suitably be used in addition to a known AC impedance method.

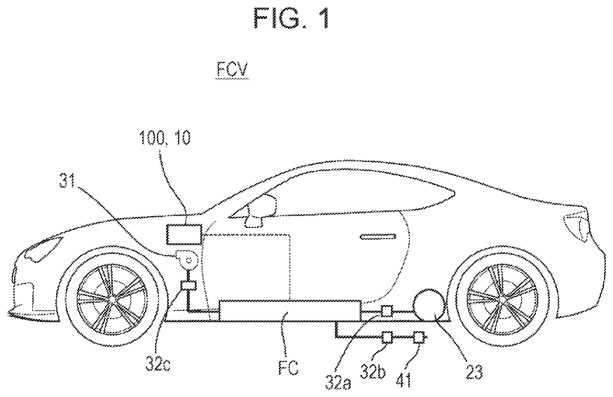

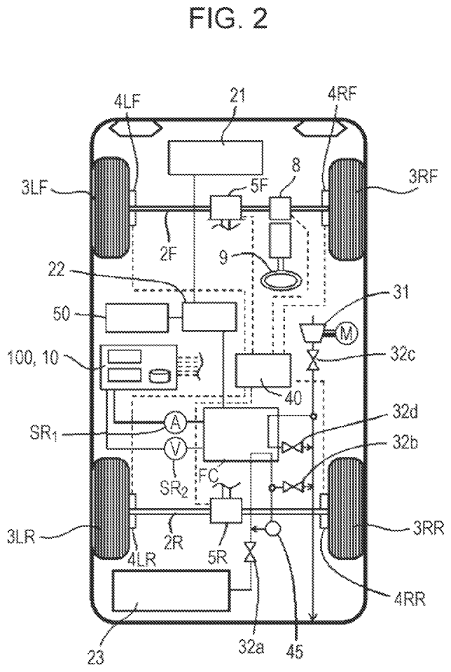

FIG. 1 is a schematic view illustrating an example of the configuration of a fuel cell vehicle FCV equipped with a fuel cell stack FC according to the embodiment. FIG. 2 is a schematic view illustrating elements and functions of the fuel cell vehicle FCV in FIG. 1. As illustrated in FIG. 2, the fuel cell vehicle FCV is formed as a four-wheel drive vehicle that transmits driving torque output from a drive power source 21, which generates driving torque for the fuel cell vehicle FCV, to a left front wheel 3LF, a right front wheel 3RF, a left rear wheel 3LR, and a right rear wheel 3RR (hereinafter simply called the wheels 3 unless it is necessary to distinguish them from each other). As the drive power source 21, a known electric motor, which is placed near the front wheels, can be used in the embodiment.

Regarding the electric motor used as the drive power source 21 in the embodiment, one electric motor may be provided for the front wheels and another one may be provided for the rear wheels, or one electric motor may be provided for each of the wheels 3. The drive power source 21 may include an internal combustion engine, such as a gasoline engine, a diesel engine, or a gas turbine engine, in addition to the electric motor.

A power supply system that supplies desired electric power to the drive power source 21 includes a fuel cell stack FC, a hydrogen gas supplier, an air supplier, a secondary battery 50, a converter 22, which is known, and a control unit 100. The fuel cell stack FC is constituted by known fuel cells (hereinafter may simply be called cells), such as polymer electrolyte fuel cells (PEFCs), stacked on each other. The hydrogen gas supplier includes a hydrogen tank 23 and a pipe, both of which are known. The air supplier includes a compressor 31 and a pipe, both of which are known. Examples of the secondary battery 50 are a lithium-ion battery and a lead-acid battery. The control unit 100 controls the above-described elements of the power supply system.

In one embodiment, the control unit 100 may also serve as a “water content state determining device 10” that determines the water content state of the fuel cell stack FC. In the power supply system, the fuel cell stack FC and the secondary battery 50 can each supply electric power to loads including the above-described electric motor.

As illustrated in FIG. 2, the fuel cell stack FC is coupled to loads including the converter 22 and the drive power source 21 (electric motor). As illustrated in FIG. 2, the current and the voltage in the fuel cell stack FC are detected by a current sensor SR₁ and a voltage sensor SR₂, respectively, which are known.

The converter 22 includes a known AC-to-DC converter that converts an alternating current (AC) into a direct current (DC) and a known DC-to-DC converter that adjusts a DC voltage to a desired voltage. In one example, the converter 22 in the embodiment has the following functions. In response to receiving a control signal from the control unit 100, the converter 22 can set an output voltage of electric power to be generated by the fuel cell stack FC and to be output therefrom. The converter 22 can also boost electric power generated by the fuel cell stack FC to a desired voltage when the fuel cell stack FC supplies generated power to a load.

As equipment used for driving control, the fuel cell vehicle FCV in the embodiment includes the above-described drive power source 21, an electric power steering device 8, and braking devices 4LF, 4RF, 4LR, and 4RR (hereinafter simply called the braking devices 4 unless it is necessary to distinguish them from each other).

The drive power source 21 outputs driving torque to be transmitted to a front-wheel drive shaft 2F and a rear-wheel drive shaft 2R via a transmission, which is not illustrated, and via a front-wheel differential mechanism 5F and a rear-wheel differential mechanism 5R. The driving of the drive power source 21 and the transmission is controlled by a known controller including one or more electronic control units (ECUs).

The electric power steering device 8 is provided on the front-wheel drive shaft 2F. The electric power steering device 8 includes an electric motor and a gear mechanism, which are not illustrated, and adjusts the steering angles of the left front wheel 3LF and the right front wheel 3RF under the control of a vehicle drive control device 20, which will be discussed below.

The vehicle drive control device 20 includes one or more known ECUs. One or more ECUs control the driving of the drive power source 21, which outputs driving torque for the fuel cell vehicle FCV, the electric power steering device 8, which controls the steering angle of a steering wheel 9 or the wheels 3, and the braking devices 4, which control the braking force of the fuel cell vehicle FCV. The vehicle drive control device 20 may also be able to control the driving of the transmission that changes the speed of rotation for electric power output from the drive power source 21 and transmits electric power to the wheels 3.

As illustrated in FIG. 2, in the hydrogen gas supplier that supplies a fuel (hydrogen) gas to the fuel cell stack FC, a hydrogen gas stored in the hydrogen tank 23 is supplied to the flow channel on the anode side of the fuel cell stack FC via a hydrogen suction valve 32a, for example. The hydrogen suction valve 32a is configured as in a known suction valve and is disposed in a hydrogen supply channel.

Part of the hydrogen gas discharged from the fuel cell stack FC may flow back to the hydrogen supply channel by a known circulator pump 45 via a circulation channel. Under the control of the control unit 100, the remaining hydrogen gas discharged from the fuel cell stack FC is released into air (exhausted) after being diluted by a known diluter 41 at a predetermined timing controlled by the opening/closing operation of a known hydrogen exhaust valve 32b.

As illustrated in FIG. 2, the air supplier that supplies an oxygen gas (air) to the fuel cell stack FC includes a known oxygen suction valve 32c and a known air emission valve 32d (back-pressure regulating valve) that adjust the amount of oxygen (air) supplied to the cells, in addition to the above-described compressor 31. The air supplier may also include a known flow rate sensor (not illustrated) that can measure the flow rate of air to be supplied to the fuel cell stack FC.

Air input by the compressor 31 is supplied to the flow channel on the cathode side of the fuel cell stack FC via the oxygen suction valve 32c and a known humidifier (not illustrated). Air supplied to the cells is output to the diluter 41 as a cathode off-gas via the air emission valve (back-pressure regulating valve) 32d under the control of the control unit 100.

The control unit 100 includes one or more processors (central processing units (CPUs)) and one or more storage devices (memory units). One or more processors and one or more storage devices are coupled to each other so that they can communicate with each other. The control unit 100 may be formed as a set of one or more ECUs. The control unit 100 may be connectable to a known external network NET, such as the internet, via various known communication devices CD, such as a smartphone.

The compressor 31, valves 32 (hydrogen suction valve 32a, hydrogen exhaust valve 32b, oxygen suction valve 32c, and air emission valve 32d), and known sensors SR, such as the current sensor SR₁ and the voltage sensor SR₂, are electrically coupled to the control unit 100 directly or via a communication medium, such as a controller area network (CAN) or a local interconnect network (LIN).

The fuel cell stack FC in the embodiment has a stacked structure, for example, in which known cells, each having electromotive force of about 1 V, are serially coupled and are stacked on each other. In one example, as the fuel cell stack FC of the embodiment, PEFCs, which are serially coupled to each other to implement the system voltage used for the fuel cell vehicle FCV, placed between a pair of regular end plates can be used. The end plates hold the PEFCs therebetween by applying pressure at both ends thereto.

The structure of each of the cells forming the fuel cell stack FC is as follows. A known membrane electrode assembly (MEA) is interposed between a pair of regular separators. One of the separators is placed at the fuel electrode side of a cell, while the other separator is placed at the air electrode side of the cell. The MEA includes at least a known cathode catalyst layer, a known anode catalyst layer which is disposed to face the cathode catalyst layer, and a known polymer electrolyte membrane disposed between the cathode catalyst layer and the anode catalyst layer. The MEA may also include an air-electrode-side gas diffusion layer and a fuel-electrode-side gas diffusion layer, both of which are known.

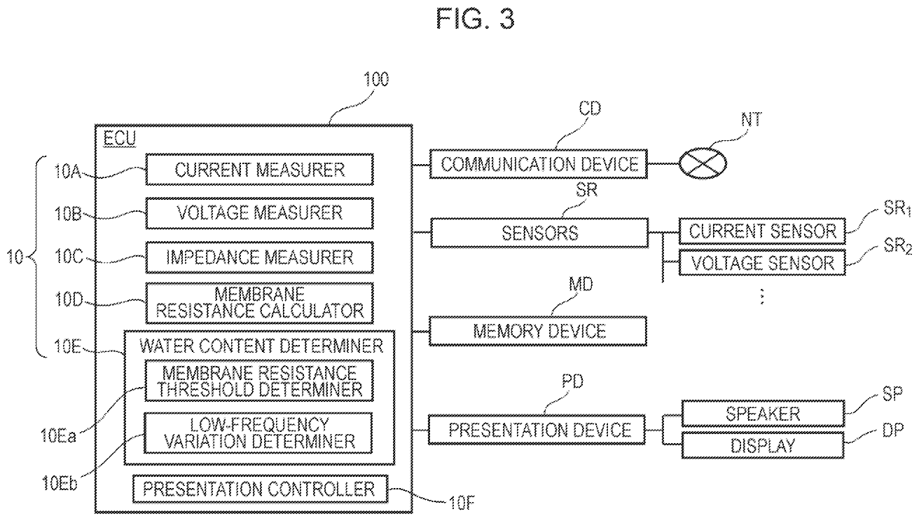

A description will now be given, with reference to FIG. 3, of a water content state determining device 10 that determines the water content state of a fuel cell stack FC in the embodiment. The water content state determining device 10 serves to determine the water content state of a fuel cell stack FC including one or more cells, based on the impedance measurement obtained by the application of a load waveform to the fuel cell stack FC.

In one example, the water content state determining device 10 of the embodiment includes a current measurer 10A, a voltage measurer 10B, an impedance measurer 10C, a membrane resistance calculator 10D, and a water content determiner 10E. As stated above, the water content state determining device 10 is one of the functions executed by the control unit 100 of the embodiment. As illustrated in FIG. 3, the control unit 100 may also include a presentation controller 10F.

The current measurer 10A serves to measure the current value of the fuel cell stack FC. In one example, the current measurer 10A in the embodiment is able to measure a current flowing through the fuel cell stack FC by using the current sensor SR₁.

The voltage measurer 10B serves to measure the voltage value of the fuel cell stack FC. In one example, the voltage measurer 10B in the embodiment is able to measure the voltage applied to the fuel cell stack FC by using the voltage sensor SR₂.

The impedance measurer 10C serves to measure the AC impedance of the fuel cell stack FC by applying an AC signal for measurement to the fuel cell stack FC. The impedance measurer 10C may use a known AC impedance method to measure the AC impedance of the fuel cell stack FC in the following manner. The impedance measurer 10C applies an AC current used for measurement to a drive current supplied to the drive power source 21 (electric motor), thereby measuring the AC impedance of the fuel cell stack FC. For example, the impedance measurer 10C in the embodiment may measure the impedance of a specific cell forming the fuel cell stack FC or measure the impedance of each cell forming the fuel cell stack FC.

The membrane resistance calculator 10D serves to calculate the membrane resistance Rmem within a fuel cell forming the fuel cell stack FC at the time of the impedance measurement, based on the impedance measured by the impedance measurer 10C. In one example, the membrane resistance calculator 10D in the embodiment generates a Cole-Cole plot from the impedance measured by the impedance measurer 10C according to a known technique and calculates the membrane resistance Rmem based on the Cole-Cole plot.

The water content determiner 10E serves to determine the water content state of one or multiple cells in the fuel cell stack FC. In one example, as illustrated in FIG. 3, the water content determiner 10E includes a membrane resistance threshold determiner 10Ea and a low-frequency variation determiner 10Eb. The membrane resistance threshold determiner 10Ea determines whether the membrane resistance Rmem based on the impedance measurement exceeds a first threshold, which will be discussed later. The low-frequency variation determiner 10Eb determines whether the degree of variations on the low-frequency side in the impedance measurement exceed a second threshold.

The water content determiner 10E is able to determine whether the one or more cells are in the dry state (whether the one or more cells have dried out, for example) by using the membrane resistance threshold determiner 10Ea, based on whether the membrane resistance Rmem of the one or more cells exceed the first threshold. The value of the first threshold may differ in accordance with the number of cells of the fuel cell stack FC or the specification value of the rated voltage or current. An example of the specific value of the first threshold can thus be determined by preliminary experiment or simulation. As a non-limiting example, in the embodiment, the value of the first threshold is set to 35 mΩ. As stated above, however, the specific value of the first threshold may be variously set in accordance with the specification of a vehicle and/or a fuel cell.

If the membrane resistance is found to be smaller than or equal to the first threshold by the membrane resistance threshold determiner 10Ea and if the degree of variations on the low-frequency side in the impedance measurement are found to exceed the second threshold by the low-frequency variation determiner 10Eb, the water content determiner 10E can determine that the one or more cells are in a flooding state.

As pointed out in JP-A No. 2018-181534, the “low-frequency side” is a frequency band in which variations in the measurement accuracy of a water content of cells are observed. The low-frequency band is a band of 1 to 150 Hz, for example.

The “degree of variations” is a degree of variations determined based on a suitable state of the water content. The suitable state of the water content is a state in which the one or more cells are neither in a dry state nor in a flooding state, which would otherwise cause a fuel cell to malfunction. Various known techniques may be applicable to the measuring of the “degree of variations”. As one example, the degree of variations may be determined based on the total area of polygons constituted by plural measurement points along the frequency on the low-frequency side, which will be discussed later. In this technique, a graph of a suitable state of the water content of the one or more cells is prepared by preliminary experiment or simulation. Then, the degree of variations is determined based on the suitable state by using the area calculated from this graph.

The second threshold is calculated based on the frequency in an AC signal used for the above-described impedance measurement and based on the phase difference between the current applied to the one or more cells forming the fuel cell stack FC and the output voltage. This will be discussed later. The value of the second threshold is different from that of the first threshold. The specific value of the second threshold can be determined by preliminary experiment or simulation in accordance with the specification of the fuel cell stack FC, for example, as in the first threshold.

As described above, the water content determiner 10E can determine the water content state of the fuel cell stack FC, that is, whether the amount of water in the fuel cell stack FC is suitable. Based on a Nyquist diagram (Cole-Cole plot) obtained from the above-described AC impedance, for example, the water content determiner 10E can calculate the membrane resistance Rmem in the Nyquist diagram and the degree of variations on the low-frequency side in the Nyquist diagram.

The water content determiner 10E in the embodiment determines the water content state of the fuel cell stack FC, based on a Nyquist diagram (Cole-Cole plot). However, a Cole-Cole plot may not necessarily be used to determine the water content state. The water content determiner 10E may determine the water content state by using the membrane resistance Rmem and/or the measurement points on the low-frequency side based on the relationship between the impedance and the measured frequency, which is generated based on the load waveform applied to the fuel cell stack FC.

The presentation controller 10F executes processing for displaying various types of information, such as alerts regarding the state of the fuel cell stack FC and the deterioration of the one or more cells, by using a presentation device PD including a known in-vehicle speaker SP and a known display DP. The presentation controller 10F may present the above-described various types of information to a vehicle occupant by using the presentation device PD or by accessing an external terminal, such as a smartphone, of the occupant.

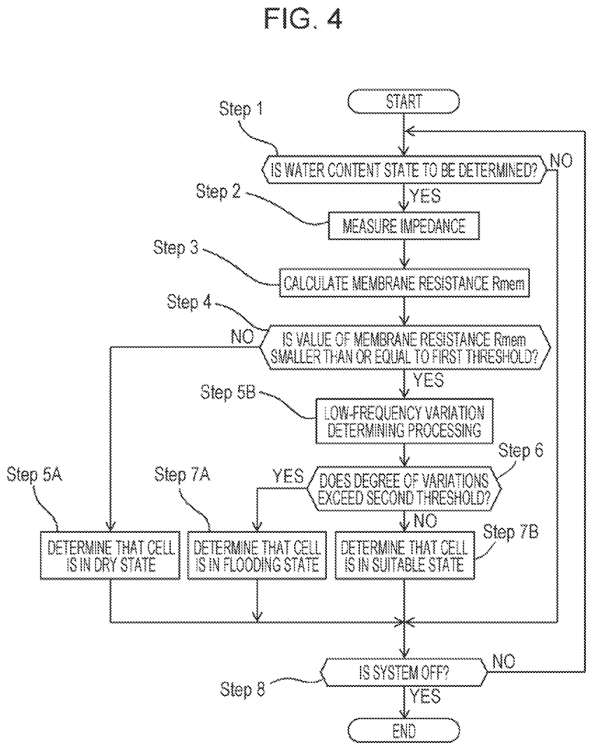

A description will now be given, with reference to FIGS. 4 through 6C, of a method for determining the water content state of a fuel cell stack, which can be executed by the control unit 100 including the water content state determining device 10 according to the embodiment. This method may be used as an algorithm for a computer-readable program. To distribute a program having such an algorithm, the program may be downloaded into the fuel cell vehicle FCV via an existing network or be stored in a recording medium.

The control unit 100 may start executing the method illustrated in FIG. 4 when a user turns ON the system of the fuel cell vehicle FCV and starts driving, for example.

In step 1, the water content state determining device 10 determines whether it is time to determine the water content state of the fuel cell stack FC. The timing at which the determination of the water content state is started may be when a known temperature sensor (not illustrated), for example, indicates that the fuel cell stack FC has reached an appropriate temperature or when a predetermined time has elapsed after the use of the fuel cell stack FC has started. Alternatively, the determination of the water content state may be started when the fuel cell stack FC has reached an appropriate temperature and when a load on the fuel cell stack FC is relatively small, such as when the fuel cell vehicle FCV is driving at a constant speed.

Then, if it is not time to determine the water content state of the fuel cell stack FC (NO in step 1), the water content state determining device 10 proceeds to step 8 to determine whether the system is OFF. If it is found in step 8 that the system is not OFF, the water content state determining device 10 returns to step 1 to repeat the above-described processing.

If it is time to determine the water content state of the fuel cell stack FC (YES in step 1), the water content state determining device 10 (impedance measurer 10C) applies an AC signal to the fuel cell stack FC in a known manner to measure the AC impedance of the fuel cell stack FC in step 2. The AC signal to be applied to the fuel cell stack FC to measure the AC impedance may be a signal in any form if it is able to measure the impedance of the fuel cell stack FC. Various waveforms used in a known AC impedance method, such as the waveform discussed in JP-A No. 2018-181534, may be applicable.

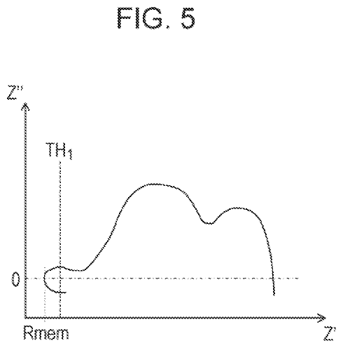

After measuring the impedance of the fuel cell stack FC in step 2, the water content state determining device 10 calculates the membrane resistance Rmem of the one or more cells forming the fuel cell stack FC in step 3. In one example, the water content state determining device 10 (membrane resistance calculator 10D) generates a Cole-Cole plot based on the impedance measured by the impedance measurer 10C, as illustrated in FIG. 5, and calculates the membrane resistance Rmem based on the Cole-Cole plot. In the embodiment, the water content state determining device 10 calculates the membrane resistance Rmem of the one or more cells forming the fuel cell stack FC, based on the Cole-Cole plot. However, the water content state determining device 10 may calculate the membrane resistance Rmem by using another known technique.

After calculating the membrane resistance Rmem of the one or more cells in step 3, the water content state determining device 10 executes membrane resistance threshold determining processing to determine whether the value of the membrane resistance Rmem is smaller than or equal to a predetermined threshold in step 4.

In one example, as illustrated in FIG. 5, the membrane resistance threshold determiner 10Ea determines whether the membrane resistance Rmem calculated in step 3 is smaller than or equal to the above-described first threshold TH₁. Since, in the example in FIG. 5, the membrane resistance Rmem is smaller than the above-described first threshold TH₁, the control unit 100 can determine that the one or more cells forming the fuel cell stack FC are not dry (not in a dry state). As described above, the first threshold TH₁ is set to 35 mΩ, for example.

If the membrane resistance Rmem exceeds the first threshold TH₁ (NO in step 4), the control unit 100 proceeds to step 5A to determine that the one or more cells forming the fuel cell stack FC are dry (in a dry state, as disclosed in JP-A No. 2018-181534). If the membrane resistance Rmem is smaller than or equal to the first threshold TH₁ (YES in step 4), the control unit 100 proceeds to step 5B and step 6 and executes low-frequency variation determining processing, which will be discussed below.

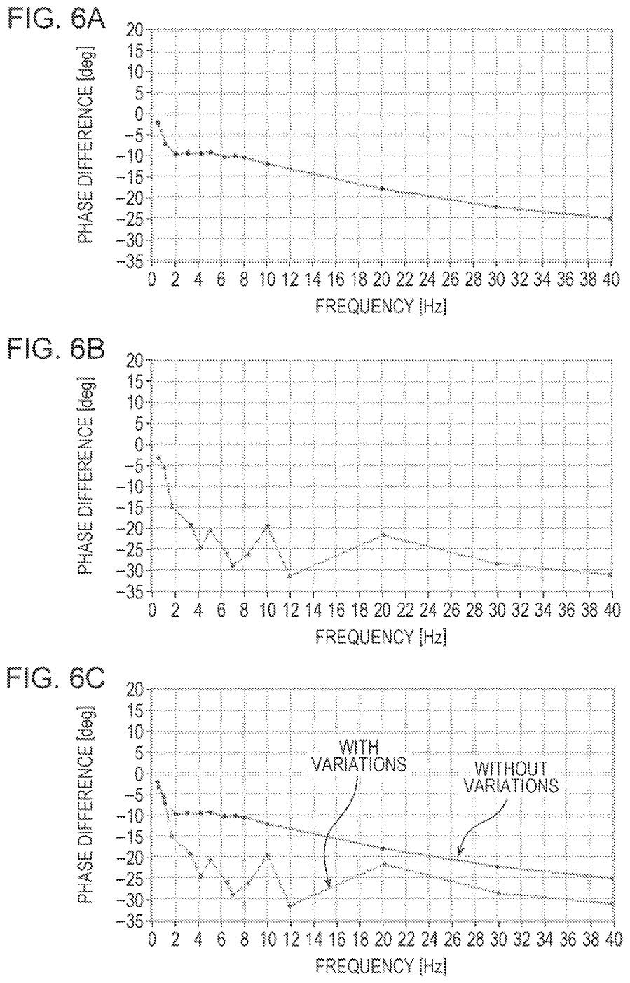

As illustrated in FIGS. 6A through 6C, the low-frequency variation determiner 10Eb first calculates the degree of variations on the low-frequency side in a Cole-Cole plot generated based on the measured impedance. In the embodiment, a range of 0.5 to 40 Hz is set as an example of the above-described low-frequency side.

The degree of variations on the low-frequency side in a Cole-Cole plot may be changeable in accordance with some factors, such as the water content state of the fuel cell stack FC. For reference: an example of a Cole-Cole plot of a fuel cell stack FC without low-frequency variations is illustrated in FIG. 6A; an example of a Cole-Cole plot of a fuel cell stack FC with low-frequency variations is illustrated in FIG. 6B; and the Cole-Cole plot of a fuel cell stack FC without low-frequency variations in FIG. 6A and the Cole-Cole plot of a fuel cell stack FC with low-frequency variations in FIG. 6B are illustrated together in FIG. 6C.

The degree of variations on the low-frequency side in the embodiment is determined in the following manner, for example. In step 5B, the low-frequency variation determiner 10Eb determines the degree of variations as follows. In FIGS. 6A through 6C, the frequency of an AC signal for impedance measurement is taken on the X axis, and the phase difference between the current applied to the one or more cells forming the fuel cell stack FC and the output voltage is taken on the Y axis. The low-frequency variation determiner 10Eb determines the degree of variations based on the total area of polygons constituted by plural measurement points (in this example, the polygons are triangles each formed by linking three points adjacent to each other on the Y axis) along the frequency on the low-frequency side on the XY coordinate plane in FIGS. 6A through 6C. The total area of the polygons can be calculated by an existing formula, for example.

In the embodiment, “100” is set as a reference value of the total area of the polygons constituted by plural measurement points along the frequency. That is, “100” is set as the second threshold. However, “100” is only an example, and various numeric values may be set as the reference value in accordance with the specifications of a vehicle and/or a fuel cell. The low-frequency variation determiner 10Eb determines in step 6 whether the total area of polygons (the degree of variations) calculated in step 5B exceeds the second threshold. If the total area of the polygons (the degree of variations) is found to exceed the second threshold in step 6, the low-frequency variation determiner 10Eb proceeds to step 7A and determines that the one or more cells are in a flooding state. The flooding state is a state in which the power generation reaction is impaired due to the accumulation of water generated in a reaction process of a fuel cell.

If it is found in step 6 that the total area of the polygons (the degree of variations) does not exceed the second threshold, the low-frequency variation determiner 10Eb proceeds to step 7B and determines that the one or more cells are in a suitable state, that is, the one or more cells are neither in the dry state nor in the flooding state.

In the embodiment, the degree of variations on the low-frequency side is calculated based on the total area of polygons. However, the disclosure is not restricted to this mode. Various known techniques that can determine the degree of variations based on the transition of the measurement points in the graphs of FIGS. 6A through 6C may be used to determine the degree of variations on the low-frequency side.

If the control unit 100 of the embodiment has determined that the water content state of the fuel cell stack FC is “dry” or “flooding”, the water content state of the fuel cell stack FC may be improved by using known various techniques.

Even with variations on the low-frequency side of an AC signal used for impedance measurement, the control unit 100 including the water content state determining device 10 of the embodiment can utilize the variations to determine the water content state of the one or more cells. The control unit 100 can thus determine the water content state of a fuel cell with high accuracy without increasing a calculation load.

The embodiment has been described above in detail with reference to the accompanying drawings. However, the disclosure is not restricted to the embodiment. It is apparent that practitioners skilled in the art pertaining to that of the disclosure can conceive various modifications or variations without departing from the scope and spirit of the disclosure, and it is understood that such modifications or variations are also encompassed in the technical scope of the disclosure.

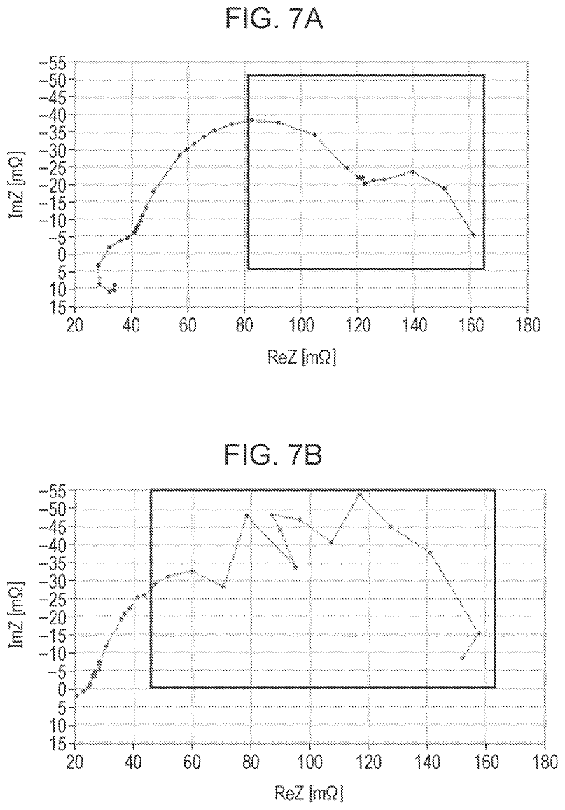

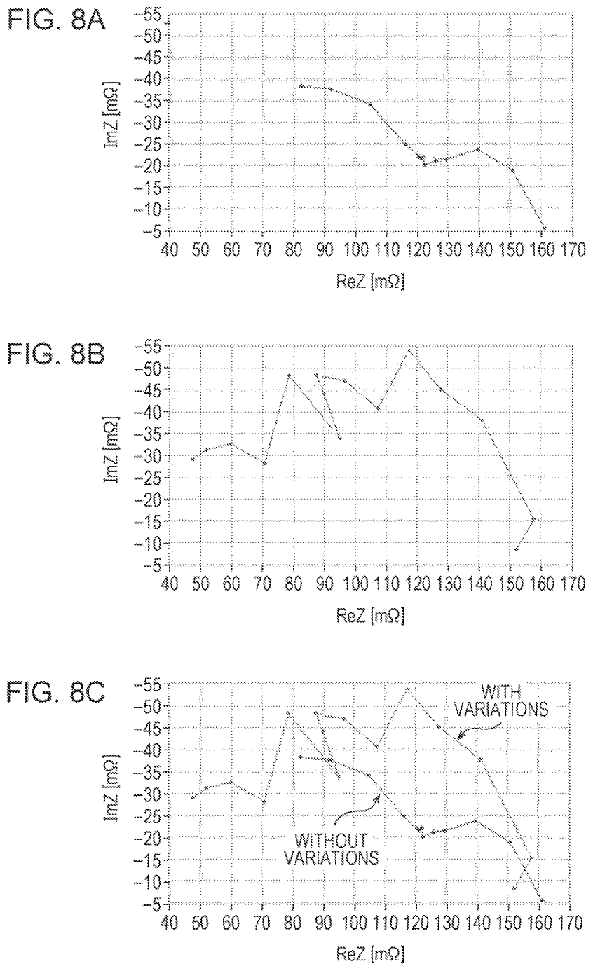

For example, the low-frequency variation determiner 10Eb calculates the degree of variations on the low-frequency side, based on the graphs each illustrating the relationship between the phase difference and the frequency in FIGS. 6A through 6C. However, the embodiment is not limited to this mode. For example, the low-frequency variation determiner 10Eb may determine the degree of variations by using the Cole-Cole plots in FIGS. 7A through 8C in which the X axis is a real axis and the Y axis is an imaginary axis. The low-frequency variation determiner 10Eb may determine the degree of variations based on a difference of multiple measurement points along the real axis from estimate values. The Cole-Cole plots without low-frequency variations are illustrated in FIGS. 7A and 8A. The Cole-Cole plots with low-frequency variations are illustrated in FIGS. 7B and 8B. The Cole-Cole plot without low-frequency variations within the rectangular frame in FIG. 7A and the Cole-Cole plot with low-frequency variations within the rectangular frame in FIG. 7B are illustrated together in FIG. 8C.

The low-frequency variation determiner 10Eb may divide the measurement range represented by the real axis into a first range having a high frequency density and a second range having a low frequency density and analyze the measurement points in each of the first and second ranges. Since the contribution of the second range to determining the degree of variations is low, the low-frequency variation determiner 10Eb may perform measurement and analysis by reducing the processing load on the second range. In contrast, since the contribution of the first range to determining the degree of variations is high, the low-frequency variation determiner 10Eb may perform measurement and analysis by using more measurement points than those in the second range.

According to an embodiment of the disclosure, it is possible to measure the water content state of a fuel cell with high accuracy without increasing a calculation load as a result of effectively utilizing the low-frequency side of an AC signal used for measurement.

The control unit 100 illustrated in FIG. 3 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the control unit 100 including the current measurer 10A, the voltage measurer 10B, the impedance measurer 10C, the membrane resistance calculator 10D, the water content determiner 10E, and the presentation controller 10F. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 3.

1. A device comprising
a control unit configured to determine a water content state of a fuel cell stack including one or more cells based on impedance measurement obtained by applying a load waveform for the impedance measurement to the fuel cell stack,
wherein the control unit is configured to
determine whether the one or more cells of the fuel cell stack are in a dry state according to whether a value of membrane resistance of the one or more cells based on the impedance measurement exceeds a first threshold, and
determine that the one or more cells are in a flooding state when the value of the membrane resistance is smaller than or equal to the first threshold and when a degree of variations on a low-frequency side in the impedance measurement exceeds a second threshold, a value of the second threshold being different from a value of the first threshold.

2. The device according to claim 1, wherein the degree of the variations on the low-frequency side is calculated based on a frequency in an alternating current signal used for the impedance measurement and based on a phase difference between a current applied to the one or more cells and an output voltage.

3. The device according to claim 2, wherein the control unit is configured to determine, on an XY coordinate plane in which an X axis indicates the frequency in the alternating current signal and a Y axis indicates the phase difference, the degree of the variations from a total area of polygons constituted by multiple measurement points along the frequency.

4. A fuel cell vehicle comprising:
a fuel cell stack; and
the device according to claim 1.

5. A fuel cell vehicle comprising:
a fuel cell stack; and
the device according to claim 2.

6. A fuel cell vehicle comprising:
a fuel cell stack; and
the device according to claim 3.

7. A device comprising
circuitry configured to determine a water content state of a fuel cell stack including one or more cells based on impedance measurement obtained by applying a load waveform for the impedance measurement to the fuel cell stack,
wherein the circuitry is configured to
determine whether the one or more cells of the fuel cell stack are in a dry state according to whether a value of membrane resistance of the one or more cells based on the impedance measurement exceeds a first threshold, and
determine that the one or more cells are in a flooding state when the value of the membrane resistance is smaller than or equal to the first threshold and when a degree of variations on a low-frequency side in the impedance measurement exceeds a second threshold, a value of the second threshold being different from a value of the first threshold.
